(19) United States
(12) Patent Application Publication
(10) Pub. No.: US 2023/0281964 A1
(43) Pub. Date: Sep. 7, 2023

(54) DEEP METRIC LEARNING MODEL TRAINING WITH MULTI-TARGET ADVERSARIAL EXAMPLES

(71) Applicant: NEC CORPORATION, Tokyo (JP)

(72) Inventors: Inderjeet SINGH, Tokyo (JP); Kazuya KAKIZAKI, Tokyo (JP); Toshinori ARAKI, Tokyo (JP)

(21) Appl. No.: 17/687,540

(22) Filed: Mar. 4, 2022

(51) Int. Cl. G06V 10/774; G06N 3/08; G06V 10/776

(52) U.S. Cl. CPC G06V 10/774; G06N 3/08; G06V 10/776

(57) ABSTRACT

Deep metric learning models are trained with multi-target adversarial examples by initializing a perturbation applied to a clean sample selected from a training sample set to form an adversarial example, the clean sample associated with a label sample, applying a deep metric learning model to the adversarial example and a plurality of target samples selected from the training sample set to obtain an adversarial feature vector and a plurality of target feature vectors, respectively, adjusting the perturbation to reduce difference among the adversarial feature vector and the plurality of target feature vectors to generate a multi-target adversarial example, applying the deep metric learning model to the clean sample, the label sample, and the multi-target adversarial example to obtain a clean feature vector, a label feature vector, and a multi-target adversarial feature vector, respectively, and adjusting the deep metric learning model based on the clean feature vector, the label feature vector, and the multi-target adversarial feature vector.

### BACKGROUND

Metric learning is a machine learning approach based on distance/similarity functions that aim to establish similarity or dissimilarity between samples, such as images. Metric learning in which the metric is computed based on discriminatory features learned by a Deep Neural Network (DNN) is sometimes referred to as Deep Metric Learning (DML). Applications of DML include face recognition, face verification, information retrieval, image classification, anomaly detection, data dimensionality reduction, etc.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a deep metric learning model, according to at least some embodiments of the present invention.

FIG. 2 is an operational flow for deep metric learning model training with multi-target adversarial examples, according to at least some embodiments of the present invention.

FIG. 3 is an operational flow for generating multi-target adversarial examples, according to at least some embodiments of the present invention.

FIG. 4 is a sample input for a deep metric learning model, according to at least some embodiments of the present invention.

FIG. 5 is an adversarial example without perturbation adjustment, according to at least some embodiments of the present invention.

FIG. 6 is a multi-target adversarial example with perturbation adjustment, according to at least some embodiments of the present invention.

FIG. 7 is a deep feature space map, according to at least some embodiments of the present invention.

FIG. 8 is a schematic diagram of a portion of a deep metric learning model, according to at least some embodiments of the present invention.

FIG. 9 is a schematic diagram of a portion of a deep metric learning model with auxiliary batch normalization layers, according to at least some embodiments of the present invention.

FIG. 10 is an operational flow for applying a deep metric learning model to samples and multi-target adversarial examples, according to at least some embodiments of the present invention.

FIG. 11 is an operational flow for initializing a deep metric learning model, according to at least some embodiments of the present invention.

FIG. 12 is an operational flow for adjusting a deep metric learning model, according to at least some embodiments of the present invention.

FIG. 13 is a block diagram of a hardware configuration for automated negotiation agent adaptation, according to at least some embodiments of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

At least some DML models are vulnerable to well-designed input images called adversarial examples (AXs). An adversarial example is a sample with small, intentional feature perturbations that cause a machine learning model to work in a certain skewed manner to achieve the adversary's objective.

In Face Recognition Systems (FRS), when an adversarial example impersonates multiple identities against a target FRS, it is called multi-targeted AX or MasterFace AX. The concept of multi-targeted AX is not limited to FRS, and can be applied to any sample to identify as multiple classes.

In at least some embodiments, training with multi-targeted AXs results in decreased overlapping of class regions in the deep feature space. In at least some embodiments, training with multi-targeted AXs results in increased inter-class separation and decreased intra-class separation in the deep feature space.

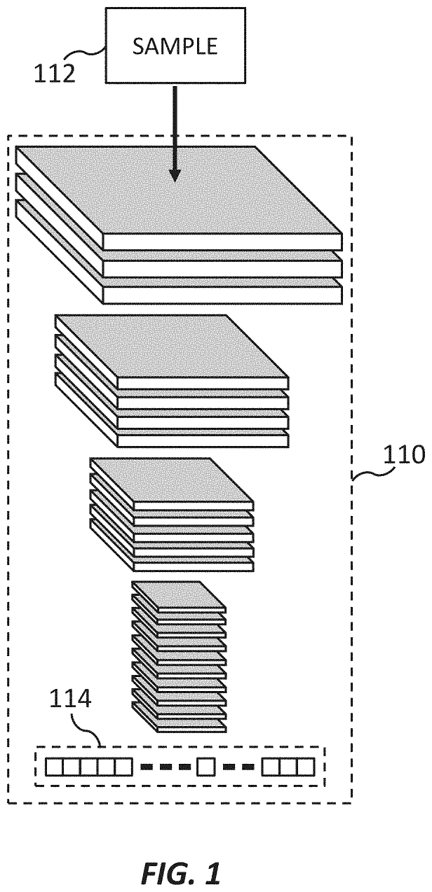

FIG. 1 is a schematic diagram of a deep metric learning model 110, according to at least some embodiments of the present invention. Deep metric learning model 110 is configured to output a feature vector 114 in the last layer in response to input of a sample 112. In at least some embodiments, deep metric learning model 110 includes multiple layers between an input layer, in which values are equal to the input sample, such as sample 112, and the last layer. In at least some embodiments, the layers of deep metric learning model 110 apply convolutions to the sample. In at least some embodiments, the layers of deep metric learning model include convolution layers, pooling layers, batch normalization layers, dense layers, dropout layers, activation layers, etc.

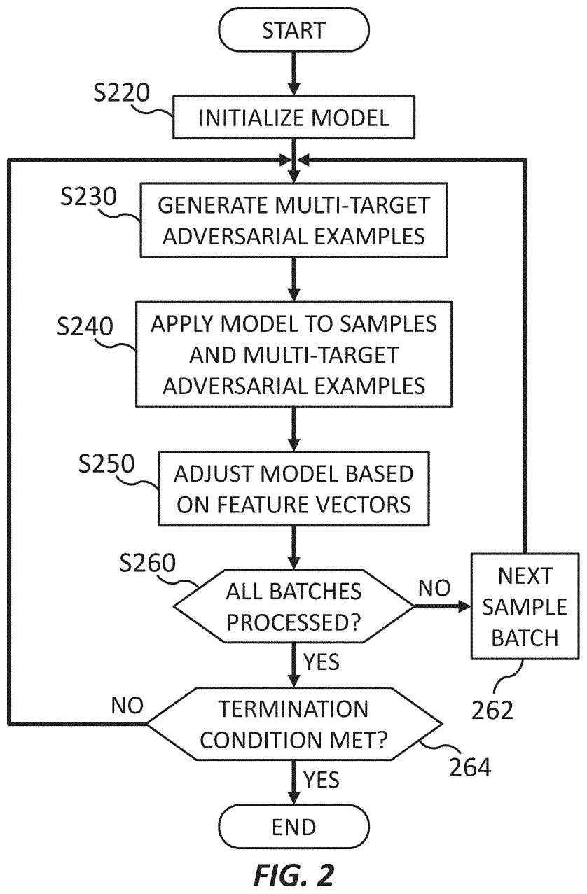

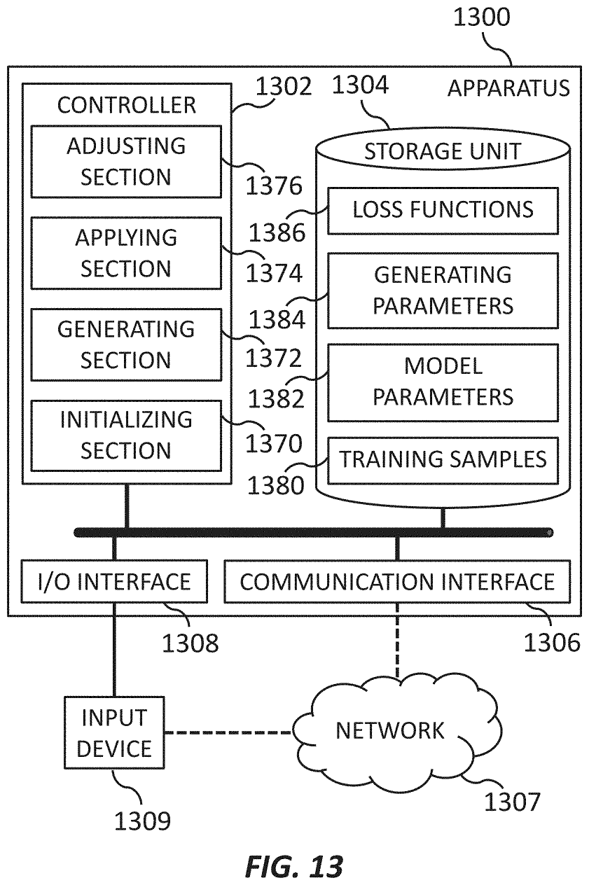

FIG. 2 is an operational flow for deep metric learning model training with multi-target adversarial examples, according to at least some embodiments of the present invention. The operational flow provides a method of deep metric learning model training with multi-target adversarial examples. In at least some embodiments, one or more operations of the method are executed by a controller of an apparatus including sections for performing certain operations, such as the controller and apparatus shown in FIG. 13, which will be explained hereinafter.

At S220, an initializing section initializes a deep metric learning model. In at least some embodiments, the initializing section initializes the deep metric learning model with random values between 0 and 1. In at least some embodiments, the initializing section initializes the deep metric learning model based on a pre-trained model.

At S230, a generating section generates multi-target adversarial examples. In at least some embodiments, the generating section applies perturbations to a training sample to generate an adversarial example, then adjusts the perturbations to generate a multi-target adversarial example. In at least some embodiments, the generating section applies the deep metric learning model to the adversarial example and a plurality of target training samples, and adjusts the perturbations based on the output.

At S240, an applying section applies the deep metric learning model to training samples, label samples, and multi-target adversarial examples. In at least some embodiments, the applying section applies the deep metric learning model to obtain feature vectors which can be mapped in feature space to estimate the corresponding class. In at least some embodiments, the applying section applies the deep metric learning model to the clean sample to obtain a clean feature vector, to the label sample to obtain a label feature vector, and to the multi-target adversarial example to obtain a multi-target adversarial feature vector. In at least some embodiments, the applying section performs calculations according to parameters of the deep metric learning model through the layers. In at least some embodiments, the applying section utilizes alternate layers depending on whether the input is a sample or an adversarial example, such as where the samples and adversarial examples are from different distributions.

At S250, an adjusting section adjusts the deep metric learning model based on the feature vectors obtained from applying the deep metric learning model to samples and multi-target adversarial examples. In at least some embodiments, the adjusting section adjusts the deep metric learning model based on the clean feature vector, the label feature vector, and the multi-target adversarial feature vector. In at least some embodiments, the adjusting section utilizes a loss function based on a comparison of feature vectors. In at least some embodiments, the loss function is based on a distance between feature vectors in feature space. In at least some embodiments, the parameters of the deep metric learning model are updated according to the result of the loss function. In at least some embodiments, the adjusting section utilizes backpropagation and gradient descent to update the parameters.

At S260, the controller or a section thereof determines whether metal batches of samples have been processed. In at least some embodiments, the controller determines whether all sample batches have been processed through iterations of S230, S240, and S250. If the controller determines that unprocessed sample batches remain, then the operational flow returns to multi-target adversarial example generation at S230 with the next sample batch (S262). If the controller determines that all sample batches have been processed, then the operational flow proceeds to S264 to determine whether a termination condition has been met.

At S264, the controller or a section thereof determines whether a termination condition is met. In at least some embodiments, the termination condition is met once a predetermined number of epochs have been completed, an epoch being one cycle of all sample batches being processed through iterations of S230, S240, and S250. In at least some embodiments, the termination condition is met once the result of the loss function falls below a threshold value. If the controller determines that the termination condition has not been met, then the operational flow returns to multi-target adversarial example generation at S230 for another epoch. If the controller determines that the termination condition has been met, then the operational flow ends.

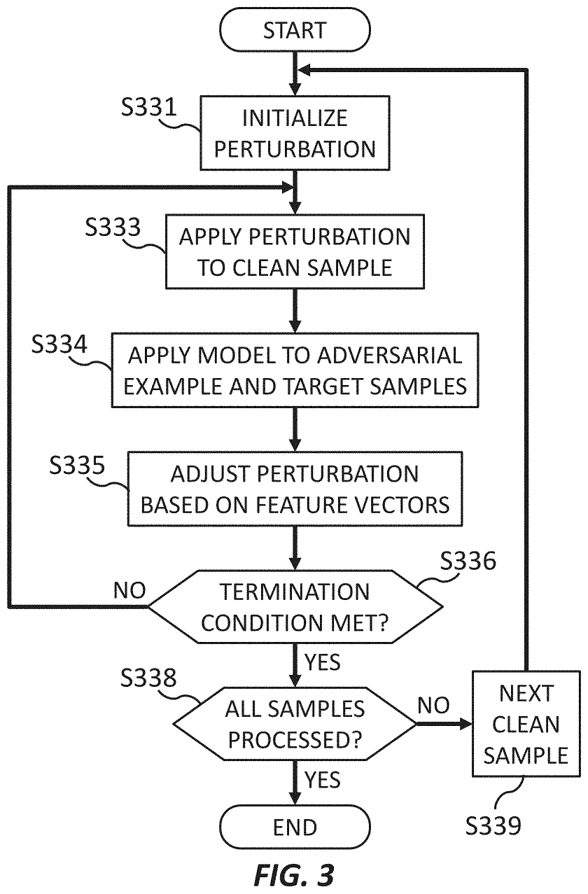

FIG. 3 is an operational flow for generating multi-target adversarial examples, according to at least some embodiments of the present invention. The operational flow provides a method of generating multi-target adversarial examples. In at least some embodiments, one or more operations of the method are executed by a generating section of an apparatus, such as the apparatus shown in FIG. 13, which will be explained hereinafter.

At S331, the generating section or a sub-section thereof initializes a perturbation. In at least some embodiments, the generating section initializes a perturbation applied to a clean sample selected from a training sample set to form an adversarial example, the clean sample associated with a label sample. In at least some embodiments, the clean sample is selected from a batch of training samples among the training sample set. In at least some embodiments, the generating section initializes the perturbation as noise, such as random values from 0 to ε, where ε is a pre-determined deviation limit. In at least some embodiments where the samples are images, the generating section initializes the noise in a predefined patch region of the image which can take any size and shape. In at least some embodiments where the samples are face images, the predefined patch region takes the shape of eyeglasses, a sticker, a hat, or any other physical object. In at least some embodiments, the predefined patch region covers the entire image, but the color deviation of the noise is constrained to preserve visibility and clarity of the image.

At S333, the generating section or a sub-section thereof applies the perturbation to the clean sample. In at least some embodiments, the generating section applies the perturbation to the clean sample to form an adversarial example. In at least some embodiments, the generating section applies the perturbation to the sample by offsetting values of the sample by corresponding perturbation values. In at least some embodiments where the samples are images, the generating section applies the patch by replacing image data of a partial area of the sample image with image data of the patch.

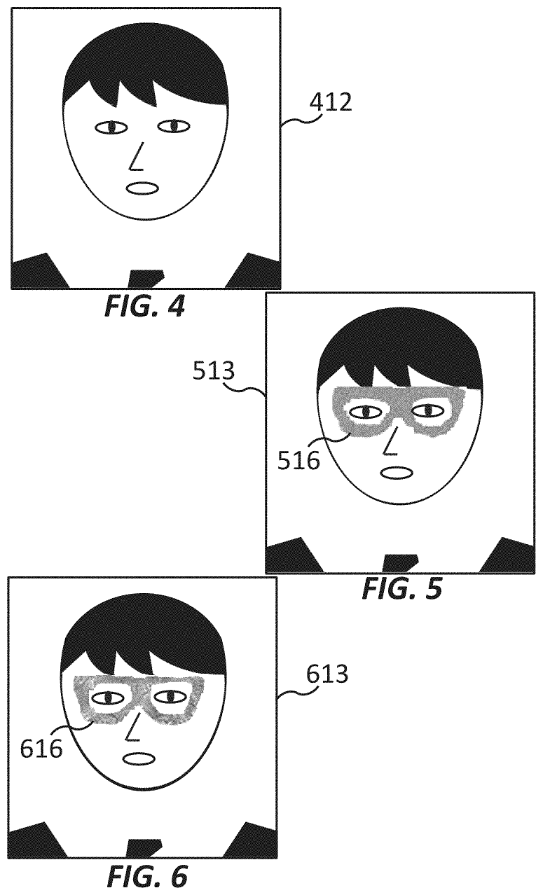

FIG. 4 is a clean sample 412 for a deep metric learning model, according to at least some embodiments of the present invention. Clean sample 412 is a face image for training a FRS. In at least some embodiments, an apparatus selects clean sample 412 from among a plurality of clean samples in a training sample set.

FIG. 5 is an adversarial example 513 without perturbation adjustment, according to at least some embodiments of the present invention. Adversarial example 513 is a face image for training a FRS. In at least some embodiments, a generating section of an apparatus applies a perturbation 516 to a source face image having a random distribution of color values. Perturbation 516 is in the shape of eyeglasses. In at least some embodiments, adversarial example 513 does not adequately identify as multiple classes because the perturbation noise has not been adjusted.

At S334, the generating section or a sub-section thereof applies the deep metric learning model to the adversarial example and target samples. In at least some embodiments, the generating section applies the deep metric learning model to the adversarial example to obtain an adversarial feature vector, and to a plurality of target samples selected from the training sample set to obtain a plurality of target feature vectors. In at least some embodiments, the generating section instructs the applying section to apply the deep metric learning model.

At S335, the generating section or a sub-section thereof adjusts the perturbation based on the feature vectors. In at least some embodiments, the generating section adjusts the perturbation to reduce difference among the adversarial feature vector and the plurality of target feature vectors to generate a multi-target adversarial example. In at least some embodiments, the generating section adjusts values of the perturbation based on the result of a loss function. In at least some embodiments, where the last layer of the deep metric learning model is a feature layer ϕ(x), multi-targeted adversarial examples (x_{m-adv}^{f}) are represented as

x_{m-adv}^{f}=x+δₘ^{f}

where x are samples, δₘ^{f} are perturbations applied to samples x to form multi-targeted AXs. In at least some embodiments, the generating section adjusts the values of the perturbation according to:

$${δ}_{m}^{f} = {argmin}_{{\vert \vert δ \vert \vert}_{p} < ϵ} \frac{1}{n} {\sum }_{{x}_{b} ∈ {S}_{B}} {\vert \vert {ϕ}^{i} ( x + δ ) - {ϕ}^{i} ( {x}_{b} ) \vert \vert}_{2} ,$$

where S_{B}←{x_{b}: x_{b} ∈Xₜᵣₐᵢₙ}, Xₜᵣₐᵢₙ is a training sample set, x_{b} are target samples, S_{B} is the batch of target samples, n is the number of target samples, ε is a deviation limit of the perturbation data, and ϕⁱ( ) is the feature vector function, which relates to the last layer of the deep metric learning model.

FIG. 6 is a multi-target adversarial example 613 with perturbation adjustment, according to at least some embodiments of the present invention. Multi-target adversarial example 613 is a face image for training a FRS. In at least some embodiments, a generating section of an apparatus adjusts a perturbation 616 to minimize, over multiple iterations, a loss function. In at least some embodiments, a feature vector obtained from application of a deep metric learning model of the FRS to multi-target adversarial example 613 occupies a location in the feature space where multiple classes overlap.

At S336, the generating section or a sub-section thereof determines whether a termination condition has been met. In at least some embodiments, the termination condition is met once the distance among feature vectors in feature space falls below a threshold value. In at least some embodiments, the termination condition is met once a pre-determined number of iterations of the operations at S333, S334, and S335 have been performed. If the generating section determines that the termination condition has not been met, then the operational flow returns to perturbation application at S333 for another iteration. In at least some embodiments, the operations of applying the deep metric learning model to the adversarial example and the plurality of target samples and adjusting the perturbation are repeated until a difference among the adversarial feature vector and the plurality of target feature vectors is less than a threshold difference value. If the generating section determines that the termination condition has been met, then the operational flow proceeds to S338 to determine whether all samples have been processed.

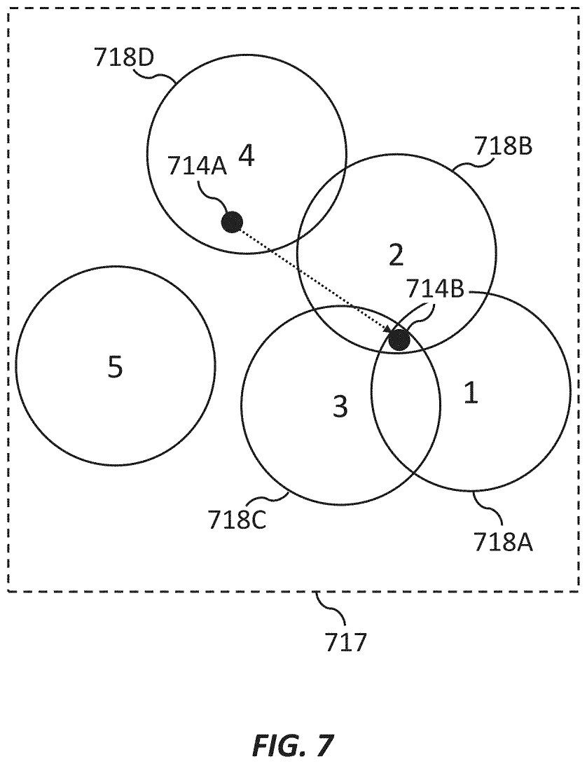

FIG. 7 is a deep feature space map 717, according to at least some embodiments of the present invention. Deep feature space map 717 includes areas associated with classes, such as class 1 area 718A, class 2 area 718B, class 3 area 718C, and class 4 area 718D. Deep feature space map 717 further includes feature vector 714A and feature vector 714B. In at least some embodiments, deep feature space map 717 is used to map output of a deep metric learning model. In at least some embodiments, feature vector 714A is output from the deep metric learning model upon application to a clean sample with an initialized perturbation, without adjustment. In at least some embodiments, as the perturbation is adjusted according to target samples of class 1, class 2, and class 3, such as in the perturbation adjustment operation at S335 of FIG. 3, the mapped location of the output feature vector moves from feature vector 714A to feature vector 714B. Feature vector 714B occupies a position where class 1, class 2, and class 3 all overlap. In at least some embodiments, training the deep metric learning model with the clean sample and adjusted perturbation, the combination of which yields a multi-target adversarial example, causes the overlapping area of class 1 area 718A, class 2 area 718B, and class 3 area 718C to shrink.

At S338, the generating section or a sub-section thereof determines whether all samples have been processed. In at least some embodiments, the generating section determines whether all samples in a batch of samples have been processed. If the generating section determines that unprocessed samples remain, then the operational flow returns to perturbation initialization at S331 with the next clean sample (S339). If the generating section determines that all samples have been processed, then the operational flow ends.

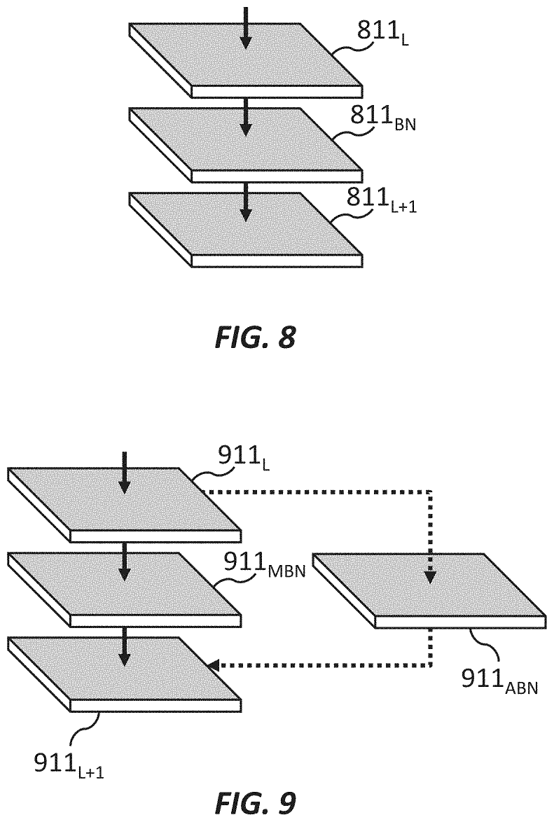

FIG. 8 is a schematic diagram of a portion of a deep metric learning model, according to at least some embodiments of the present invention. The portion includes three layers, layer 811_{L}, layer 811_{BN}, and layer 811_{L+1}. Layer 811_{BN} is a batch normalization layer. In at least some embodiments, as a sample is processed through the deep metric learning model, data flows through layer 811_{L}, layer 811_{BN}, and layer 811_{L+1} regardless of the type of sample input.

At least some embodiments utilize disentangled adversarial training, whereby separate Batch Normalization (BN) layers are used during training to handle the input clean and adversarial samples, which possibly come from different distributions.

FIG. 9 is a schematic diagram of a portion of a deep metric learning model with auxiliary batch normalization layers, according to at least some embodiments of the present invention. In at least some embodiments, the deep metric learning model includes a main batch normalization layer and an auxiliary batch normalization layer configured for substitution with the main batch normalization layer. The portion includes four layers, layer 911_{L}, layer 911_{BN}, layer 911_{ABN}, and layer 911_{L+1}. Layer 911_{BN} and layer 911_{ABN} are batch normalization layers. In at least some embodiments, as a sample is processed through the deep metric learning model, data flows through layer 911_{L}, layer 911_{BN}, and layer 911_{L+1} in response to input of a clean sample. In at least some embodiments, as a sample is processed through the deep metric learning model, data flows through layer 911_{L}, layer 911_{ABN}, and layer 911_{L+1} in response to input of an adversarial example.

At least some embodiments leverage disentangled learning and multi-targeted AXs to improve image recognition models in the DML setting. A method referred to by the inventors as AdvProp proposes to improve image recognition models using AXs. The method uses auxiliary batch normalization layers in a model during inference of AXs to enable disentangled learning during the training process to optimize the following objective:

$${argmin}_{θ} [ {E}_{x , y ∼ D} ( L ( θ , x , y ) + {max}_{δ} L ( θ , x + δ , y ) )$$

where θ is the model parameters, x is the sample, y is the label, δ is the perturbation applied to a sample x to form an AX, E_{x,y}( ) is the error function, L(θ,x,y) is the loss function of the training samples, and L(θ,x+δ,y) is the loss function of the AXs. The AdvProp method is designed for use in the classification setting, and is often more effective for models that include a classification layer. Also, the AdvProp method considers single-targeted AXs, and does not vary for use with multi-targeted AXs.

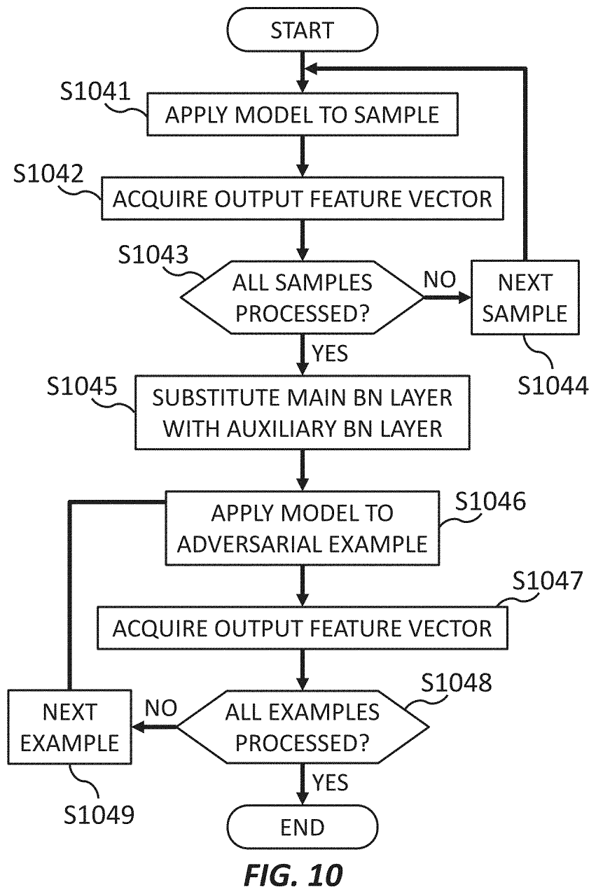

FIG. 10 is an operational flow for applying a deep metric learning model to samples and multi-target adversarial examples, according to at least some embodiments of the present invention. The operational flow provides a method of applying a deep metric learning model to samples and multi-target adversarial examples. In at least some embodiments, one or more operations of the method are executed by an applying section of an apparatus, such as the apparatus shown in FIG. 13, which will be explained hereinafter.

At S1041, the applying section or a sub-section thereof applies a deep metric learning model to a sample. In at least some embodiments, the applying section applies the deep metric learning model to a clean sample. In at least some embodiments, the applying section applies the deep metric learning model to a label sample. In at least some embodiments, the operations of applying the deep metric learning model to the clean sample and the label sample include applying the main batch normalization layer. In at least some embodiments, the applying section applies the deep metric learning model to the sample during adversarial example generation. In at least some embodiments, the applying section applies the deep metric learning model to the sample during training of the deep metric learning model.

At S1042, the applying section or a sub-section thereof acquires a feature vector output from the deep metric learning model. In at least some embodiments, the applying section stores the output feature vector in a memory for use later in calculating a loss function.

At S1043, the applying section or a sub-section thereof determines whether all samples have been processed. In at least some embodiments, the applying section determines whether all samples in a batch of samples have been processed. If the applying section determines that unprocessed samples remain, then the operational flow returns to model application at S1041 with the next sample (S1044). If the applying section determines that all samples have been processed, then the operational flow proceeds to batch normalization layer substitution at S1045.

At S1045, the applying section or a sub-section thereof substitutes a main batch normalization layer with an auxiliary batch normalization layer. In at least some embodiments, the applying section substitutes multiple main batch normalization layers with auxiliary batch normalization layers within the deep metric learning model. In at least some embodiments, the applying section substitutes parameters of each main batch normalization layer with parameters of the corresponding auxiliary batch normalization layer.

At S1046, the applying section or a sub-section thereof applies a deep metric learning model to an adversarial example. In at least some embodiments, the applying section applies the deep metric learning model to a multi-target adversarial example. In at least some embodiments, the operations of applying the deep metric learning model to the adversarial example and the multi-target adversarial example include applying the auxiliary batch normalization layer. In at least some embodiments, the applying section applies the deep metric learning model to the adversarial example during adversarial example generation. In at least some embodiments, the applying section applies the deep metric learning model to the multi-target adversarial example during training of the deep metric learning model.

At S1047, the applying section or a sub-section thereof acquires a feature vector output from the deep metric learning model. In at least some embodiments, the applying section stores the output feature vector in a memory for use later in calculating a loss function.

At S1048, the applying section or a sub-section thereof determines whether all adversarial examples have been processed. In at least some embodiments, the applying section determines whether all adversarial examples in a batch have been processed. If the applying section determines that unprocessed adversarial examples remain, then the operational flow returns to model application at S1046 with the next sample (S1049). If the applying section determines that all samples have been processed, then the operational flow ends.

In at least some embodiments, the applying section substitutes the main batch normalization layers with the auxiliary batch normalization layers more frequently than once per batch. In at least some embodiments, the applying section routes data through the appropriate layers without performing a substitution between applications. In at least some embodiments, the deep metric learning model does not include an auxiliary batch normalization layer, and the applying section processes all samples and examples according to operations S1041, S1042, S1043, and S1044.

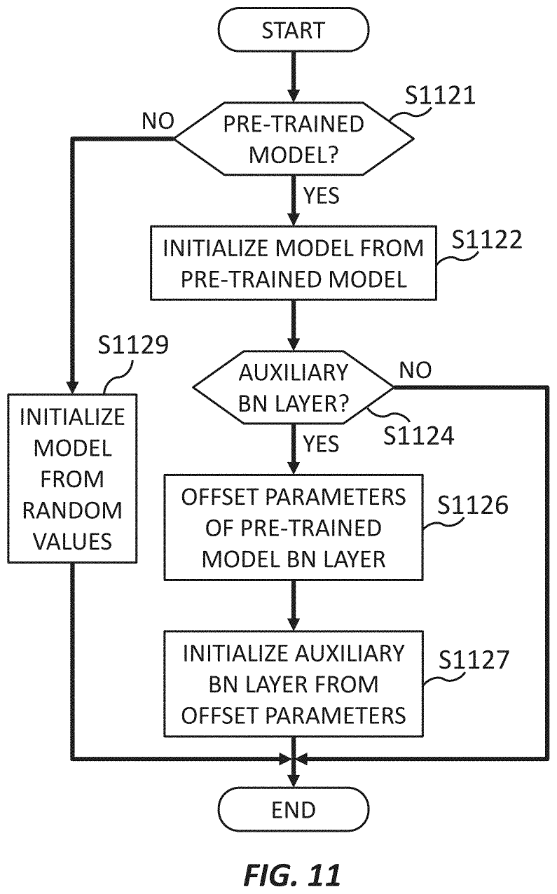

FIG. 11 is an operational flow for initializing a deep metric learning model, according to at least some embodiments of the present invention. The operational flow provides a method of initializing a deep metric learning model. In at least some embodiments, one or more operations of the method are executed by an initializing section of an apparatus, such as the apparatus shown in FIG. 13, which will be explained hereinafter.

At S1121, the initializing section or a sub-section thereof determines whether there is a pre-trained model as the basis for initialization. In at least some embodiments, the initializing section determines whether a pre-trained deep metric learning model has been provided in a memory or transmitted along with a request for initialization. If the initializing section determines that there is a pre-trained model as the basis for initialization, then the operational flow proceeds to pre-trained model based initialization at S1122. If the initializing section determines that there is no pre-trained model as the basis for initialization, then the operational flow proceeds to random based initialization at S1129.

At S1122, the initializing section or a sub-section thereof initializes the deep metric learning model from the pre-trained model. In at least some embodiments, the initializing section initializes the deep metric learning model based on the pre-trained model. In at least some embodiments, the initializing section initializes the deep metric learning model to assume the parameter values of the pre-trained model.

At S1124, the initializing section or a sub-section thereof determines whether the deep metric learning model includes an auxiliary batch normalization layer. In at least some embodiments, the initializing section determines whether parameters for the deep metric learning model include parameters for auxiliary batch normalization layers. If the initializing section determines that the deep metric learning model includes an auxiliary batch normalization layer, then the operational flow proceeds to parameter offset at S1126. If the initializing section determines that the deep metric learning model does not include an auxiliary batch normalization layer, then the operational flow ends.

At S1126, the initializing section or a sub-section thereof offsets parameters of the pre-trained model batch normalization layer. In at least some embodiments, the initializing section adds an offset value to the value of each parameter in the batch normalization layers of the pre-trained model. In at least some embodiments, the initializing section initializes auxiliary BN parameters θ_{AuxBN} from values closer to the pre-trained main BN layer parameters θ_{BN}. In at least some embodiments, the parameters {θ_{NBN}>θ_{BN}>θ_{AuxBN}} of a model are initialized as: θ_{NBN}←β_{NBN}; θ_{BN}←β_{BN}; and θ_{AuxBN}←β_{BN}+γ, where a pre-trained model's parameters are {β_{NBN}, β_{BN}}, and γ is a real number that is less than one. In at least some embodiments, γ is less than 0.1, and can be 0.

At S1127, the initializing section or a sub-section thereof initializes the auxiliary batch normalization layer of the deep metric learning model from the offset parameters. In at least some embodiments, the initialized values of the auxiliary batch normalization layer are offset from corresponding values of a pre-trained batch normalization layer of the pre-trained model. In at least some embodiments, the initializing section initializes auxiliary batch normalization layers of the deep metric learning model to assume the parameter values of the pre-trained model after adding the offset value to each parameter value.

At S1129, the initializing section or a sub-section thereof initializes the deep metric learning model from random values. In at least some embodiments, the initializing section initializes the deep metric learning model based on a random selection of value between 0 and 1 for each parameter of the deep metric learning model. In at least some embodiments, the initializing section initializes auxiliary batch normalization layers of the deep metric learning model to assume the initialized parameter values of the main batch normalization layers. In at least some embodiments, the initializing section initializes auxiliary batch normalization layers of the deep metric learning model to assume the initialized parameter values of the main batch normalization layers after adding an offset value to each parameter value. In at least some embodiments, the initializing section initializes auxiliary batch normalization layers of the deep metric learning model from random values without regard to parameter values of the main batch normalization layers.

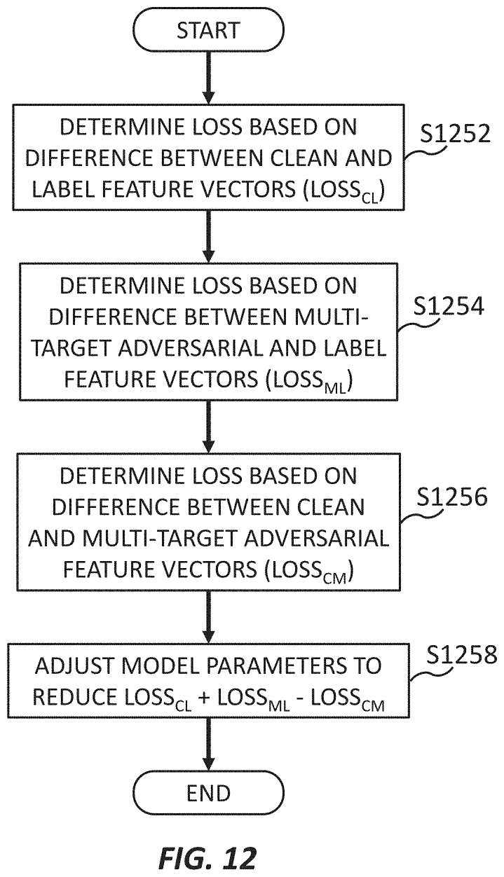

FIG. 12 is an operational flow for adjusting a deep metric learning model, according to at least some embodiments of the present invention. The operational flow provides a method of adjusting a deep metric learning model. In at least some embodiments, one or more operations of the method are executed by an adjusting section of an apparatus, such as the apparatus shown in FIG. 13, which will be explained hereinafter.

At S1252, the adjusting section or a sub-section thereof determines loss based on a difference between clean feature vectors and label feature vectors. In at least some embodiments, the adjusting section determines a loss value based on a first value representing a difference between the clean feature vector and the label feature vector. In at least some embodiments, the adjusting section determines loss based on

L_{CL}(θ,x_{c},y_{c})

where θ is the model parameters, x_{c} are clean samples, y_{c} are label samples, and L_{CL( )} is the function for loss measuring distance between clean feature vectors and label feature vectors.

At S1254, the adjusting section or a sub-section thereof determines loss based on a difference between multi-target adversarial feature vectors and label feature vectors. In at least some embodiments, the adjusting section determines a loss value based on a second value representing a difference between the multi-target adversarial feature vector and the label feature vector. In at least some embodiments, the adjusting section determines loss based on

L_{ML}(θ,x_{c}+δₘ^{f},y_{c})

where θ is the model parameters, x_{c}+δₘ^{f} are multi-target adversarial examples, y_{c} are label samples, and L_{ML( )} is the function for loss measuring distance between multi-target adversarial feature vectors and label feature vectors.

In at least some embodiments, adjusting section determines a regularization penalty to further enhance the generalization and reduce the occurrence of overfitting as:

g(θ,x_{c},x_{c}++δₘ^{f})=−∥ϕ_{θ}(x_{c})−ϕ_{θ}(x_{c}+δₘ^{f})∥ₚ

where θ is the model parameters, x_{c} are clean samples, x_{c}+δₘ^{f} are multi-target adversarial examples, ϕ_{θ}( ) is the feature vector function of the deep metric learning model, and g( ) is the regularization function measuring distance between clean feature vectors and the multi-target adversarial feature vectors.

At S1256, the adjusting section or a sub-section thereof determines loss based on a difference between clean feature vectors and multi-target adversarial feature vectors. In at least some embodiments, the adjusting section determines the loss value further based on a third value representing a difference between the clean feature vector and the multi-target adversarial feature vector. In at least some embodiments, the adjusting section determines loss based on

L_{CM}(θ,x_{c},x_{c}+δₘ^{f})

where θ is the model parameters, x_{c} are clean samples, x_{c}+δₘ^{f} are multi-target adversarial examples, and L_{CM( )} is the function for loss measuring distance between clean feature vectors and multi-target adversarial feature vectors.

At S1258, the adjusting section or a sub-section thereof adjusts parameters of the deep metric learning model to reduce the loss. In at least some embodiments, the adjusting section adjusts parameters to reduce distance between clean feature vectors and label feature vectors, to reduce distance between multi-target adversarial feature vectors and label feature vectors, and to increase distance between clean feature vectors and multi-target adversarial feature vectors:

$${argmin}_{θ} [ {E}_{( x , y ) ∼ D} ( {L}_{CL} + {L}_{ML} - {L}_{CM} ) ]$$

where E_{(x,y)˜D} ( ) is the error function based on the loss. In at least some embodiments, the adjusting section adjusts parameter values based on L_{CL} and only one of L_{ML} and L_{CM}. In other words, the adjusting section of at least some embodiments determines a loss value based on a first value representing a difference between the clean feature vector and the label feature vector, and a second value representing a difference between the multi-target adversarial feature vector and the label feature vector. In at least some embodiments in which the deep metric learning model includes an auxiliary batch normalization layer, the adjusting the deep metric learning model includes adjusting the main batch normalization layer based on the first value without regard to the second value, and adjusting the auxiliary batch normalization layer based on the second value without regard to the first value. The adjusting section of at least some embodiments determines a loss value based on a first value representing a difference between the clean feature vector and the label feature vector, and a second value representing a difference between the clean feature vector and the multi-target adversarial feature vector. In at least some embodiments, a training objective with the regularization penalty is given by:

$${argmin}_{θ} [ {E}_{( x , y ) ∼ D} ( L ( θ , {x}_{c} , {y}_{c} , ) + g ( θ , {x}_{c} , {x}_{c} + {δ}_{m}^{f} ) ) ]$$

where x_{c} are clean samples, y_{c} are label samples, x_{c}+δₘ^{f} are multi-target AXs, and g (is the regularization function measuring distance between clean feature vectors and the multi-target adversarial feature vectors.

In at least some embodiments, the adjusting section adjusts parameters of a deep metric learning model including auxiliary batch normalization layers, according to:

$${argmin}_{{θ}_{NBN} , {θ}_{BN} , {θ}_{AuxBN}} [ {E}_{( x , y ) ∼ D} ( L ( {θ}_{NBN} , {θ}_{BN} , {θ}_{AuxBN ,} \{ {x}_{c} , {x}_{c} + {δ}_{m}^{f} \} , \{ {y}_{c} , {y}_{c} \} ) ) ]$$

where x_{c}+δₘ^{f} are multi-targeted AXs in feature space, θ_{NBN} are model parameters except for BN layers, θ_{BN} are model parameters of main BN layers, and θ_{AuxBN} are model parameters of auxiliary BN layers. In at least some embodiments, the adjusting section adjusts {θ_{NBN}, θ_{BN}} parameters with respect to loss based on clean feature vectors and adjusts {θ_{NBN}, θ_{AuxBN}} parameters with respect to loss based on adversarial feature vectors.

FIG. 13 is a block diagram of a hardware configuration for automated negotiation agent adaptation, according to at least some embodiments of the present invention.

The exemplary hardware configuration includes apparatus 1300, which interacts with input device 1309, and communicates with network 1307. In at least some embodiments, apparatus 1300 is integrated with input device 1309. In at least some embodiments, apparatus 1300 is a computer system that executes computer-readable instructions to perform operations for physical network function device access.

Apparatus 1300 includes a controller 1302, a storage unit 1304, a communication interface 1306, and an input/output interface 1308. In at least some embodiments, controller 1302 includes a processor or programmable circuitry executing instructions to cause the processor or programmable circuitry to perform operations according to the instructions. In at least some embodiments, controller 1302 includes analog or digital programmable circuitry, or any combination thereof. In at least some embodiments, controller 1302 includes physically separated storage or circuitry that interacts through communication. In at least some embodiments, storage unit 1304 includes a non-volatile computer-readable medium capable of storing executable and non-executable data for access by controller 1302 during execution of the instructions. Communication interface 1306 transmits and receives data from network 1307. Input/output interface 1308 connects to various input and output units, such as input device 1309, via a parallel port, a serial port, a keyboard port, a mouse port, a monitor port, and the like to exchange information.

Controller 1302 includes initializing section 1370, generating section 1372, applying section 1374, and adjusting section 1376. Storage unit 1304 includes training samples 1380, model parameters 1382, generating parameters 1384, and loss functions 1386.

Initializing section 1370 is the circuitry or instructions of controller 1302 configured to initialize parameters of models and perturbations. In at least some embodiments, initializing section 1370 is configured initialize the deep metric learning model based on a pre-trained model. In at least some embodiments, initializing section 1370 records information in storage unit 1304, such as model parameters 1382. In at least some embodiments, initializing section 1370 includes sub-sections for performing additional functions, as described in the foregoing flow charts. In at least some embodiments, such sub-sections is referred to by a name associated with a corresponding function.

Generating section 1372 is the circuitry or instructions of controller 1302 configured generating multi-target adversarial examples. In at least some embodiments, generating section 1372 is configured to apply perturbations to a training sample to generate an adversarial example, then adjust the perturbations to generate a multi-target adversarial example. In at least some embodiments, generating section 1372 utilizes information in storage unit 1304, such as model parameters 1382 and generating parameters 1384. In at least some embodiments, generating section 1372 includes sub-sections for performing additional functions, as described in the foregoing flow charts. In at least some embodiments, such sub-sections is referred to by a name associated with a corresponding function.

Applying section 1374 is the circuitry or instructions of controller 1302 configured to apply models to samples and examples. In at least some embodiments, applying section 1374 is configured to apply a deep metric learning model to clean samples to obtain clean feature vectors, to label samples to obtain label feature vectors, and to multi-target adversarial examples to obtain multi-target adversarial feature vectors. In at least some embodiments, applying section 1374 utilizes information from storage unit 1304, such as training samples 1380 and model parameters 1382. In at least some embodiments, applying section 1374 includes sub-sections for performing additional functions, as described in the foregoing flow charts. In at least some embodiments, such sub-sections is referred to by a name associated with a corresponding function.

Adjusting section 1376 is the circuitry or instructions of controller 1302 configured to adjust values of perturbations and model parameters. In at least some embodiments, adjusting section 1376 is configured to adjust a deep metric learning model based on clean feature vectors, label feature vectors, and multi-target adversarial feature vectors. In at least some embodiments, adjusting section 1376 utilizes information from storage unit 1304, such as model parameters 1382 and loss functions 1386, and records information in storage unit 1304, such as model parameters 1382. In at least some embodiments, applying section 1374 includes sub-sections for performing additional functions, as described in the foregoing flow charts. In at least some embodiments, such sub-sections is referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

According to at least some embodiments of the present invention, deep metric learning models are trained with multi-target adversarial examples by initializing a perturbation applied to a clean sample selected from a training sample set to form an adversarial example, the clean sample associated with a label sample, applying a deep metric learning model to the adversarial example and a plurality of target samples selected from the training sample set to obtain an adversarial feature vector and a plurality of target feature vectors, respectively, adjusting the perturbation to reduce difference among the adversarial feature vector and the plurality of target feature vectors to generate a multi-target adversarial example, applying the deep metric learning model to the clean sample, the label sample, and the multi-target adversarial example to obtain a clean feature vector, a label feature vector, and a multi-target adversarial feature vector, respectively, and adjusting the deep metric learning model based on the clean feature vector, the label feature vector, and the multi-target adversarial feature vector.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a computer to cause the computer to perform operations comprising:
initializing a perturbation applied to a clean sample selected from a training sample set to form an adversarial example, wherein the clean sample is associated with a label sample;
applying a deep metric learning model to the adversarial example to obtain an adversarial feature vector, and to a plurality of target samples selected from the training sample set to obtain a plurality of target feature vectors;
adjusting the perturbation to reduce a difference among the adversarial feature vector and the plurality of target feature vectors to generate a multi-target adversarial example;
applying the deep metric learning model to the clean sample to obtain a clean feature vector, to the label sample to obtain a label feature vector, and to the multi-target adversarial example to obtain a multi-target adversarial feature vector;
adjusting the deep metric learning model based on the clean feature vector, the label feature vector, and the multi-target adversarial feature vector.

2. The computer-readable medium of claim 1,
wherein the operations of applying the deep metric learning model to the adversarial example and the plurality of target samples and adjusting the perturbation are repeated until a difference among the adversarial feature vector and the plurality of target feature vectors is less than a threshold difference value.

3. The computer-readable medium of claim 1, wherein the adjusting the deep metric learning model includes determining a loss value based on:
a first value representing a difference between the clean feature vector and the label feature vector, and
a second value representing a difference between the clean feature vector and the multi-target adversarial feature vector.

4. The computer-readable medium of claim 1, wherein the adjusting the deep metric learning model includes determining a loss value based on:
a first value representing a difference between the clean feature vector and the label feature vector, and
a second value representing a difference between the multi-target adversarial feature vector and the label feature vector.

5. The computer-readable medium of claim 4, wherein
the deep metric learning model includes a main batch normalization layer and an auxiliary batch normalization layer configured for substitution with the main batch normalization layer,
the operations of applying the deep metric learning model to the clean sample and the label sample include applying the main batch normalization layer, and
the operations of applying the deep metric learning model to the adversarial example and the multi-target adversarial example include applying the auxiliary batch normalization layer.

6. The computer-readable medium of claim 5, wherein the adjusting the deep metric learning model includes:
adjusting the main batch normalization layer based on the first value without regard to the second value, and
adjusting the auxiliary batch normalization layer based on the second value without regard to the first value.

7. The computer-readable medium of claim 6, wherein the adjusting the deep metric learning model includes determining the loss value further based on a third value representing a difference between the clean feature vector and the multi-target adversarial feature vector.

8. The computer-readable medium of claim 5, wherein the operations further comprise initializing the deep metric learning model based on a pre-trained model;
wherein initialized values of the auxiliary batch normalization layer are offset from corresponding values of a pre-trained batch normalization layer of the pre-trained model.

9. A method comprising:
initializing a perturbation applied to a clean sample selected from a training sample set to form an adversarial example, wherein the clean sample is associated with a label sample;
applying a deep metric learning model to the adversarial example to obtain an adversarial feature vector, and to a plurality of target samples selected from the training sample set to obtain a plurality of target feature vectors;
adjusting the perturbation to reduce a difference among the adversarial feature vector and the plurality of target feature vectors to generate a multi-target adversarial example;
applying the deep metric learning model to the clean sample to obtain a clean feature vector, to the label sample to obtain a label feature vector, and to the multi-target adversarial example to obtain a multi-target adversarial feature vector;
adjusting the deep metric learning model based on the clean feature vector, the label feature vector, and the multi-target adversarial feature vector.

10. The method of claim 9,
wherein the operations of applying the deep metric learning model to the adversarial example and the plurality of target samples and adjusting the perturbation are repeated until a difference among the adversarial feature vector and the plurality of target feature vectors is less than a threshold difference value.

11. The method of claim 9, wherein the adjusting the deep metric learning model includes determining a loss value based on
a first value representing a difference between the clean feature vector and the label feature vector, and
a second value representing a difference between the clean feature vector and the multi-target adversarial feature vector.

12. The method of claim 9, wherein the adjusting the deep metric learning model includes determining a loss value based on
a first value representing a difference between the clean feature vector and the label feature vector, and
a second value representing a difference between the multi-target adversarial feature vector and the label feature vector.

13. The method of claim 12, wherein
the deep metric learning model includes a main batch normalization layer and an auxiliary batch normalization layer configured for substitution with the main batch normalization layer,
the operations of applying the deep metric learning model to the clean sample and the label sample include applying the main batch normalization layer, and
the operations of applying the deep metric learning model to the adversarial example and the multi-target adversarial example include applying the auxiliary batch normalization layer.

14. The method of claim 13, wherein the adjusting the deep metric learning model includes
adjusting the main batch normalization layer based on the first value without regard to the second value, and
adjusting the auxiliary batch normalization layer based on the second value without regard to the first value.

15. The method of claim 14, wherein the adjusting the deep metric learning model includes determining the loss value further based on a third value representing a difference between the clean feature vector and the multi-target adversarial feature vector.

16. The method of claim 15, further comprising
initializing the deep metric learning model based on a pre-trained model;
wherein initialized values of the auxiliary batch normalization layer are offset from corresponding values of a pre-trained batch normalization layer of the pre-trained model.

17. An apparatus comprising:
a controller including circuitry configured to:
initialize a perturbation applied to a clean sample selected from a training sample set to form an adversarial example, wherein the clean sample is associated with a label sample;
apply a deep metric learning model to the adversarial example to obtain an adversarial feature vector, and to a plurality of target samples selected from the training sample set to obtain a plurality of target feature vectors;
adjust the perturbation to reduce a difference among the adversarial feature vector and the plurality of target feature vectors to generate a multi-target adversarial example;
apply the deep metric learning model to the clean sample to obtain a clean feature vector, to the label sample to obtain a label feature vector, and to the multi-target adversarial example to obtain a multi-target adversarial feature vector;
adjust the deep metric learning model based on the clean feature vector, the label feature vector, and the multi-target adversarial feature vector.

18. The apparatus of claim 17,
wherein the circuitry is configured to repeat the operations of applying the deep metric learning model to the adversarial example and the plurality of target samples and adjusting the perturbation until a difference among the adversarial feature vector and the plurality of target feature vectors is less than a threshold difference value.

19. The apparatus of claim 17, wherein the circuitry configured to adjust the deep metric learning model is further configured to determine a loss value based on
a first value representing a difference between the clean feature vector and the label feature vector, and
a second value representing a difference between the clean feature vector and the multi-target adversarial feature vector.

20. The apparatus of claim 17, wherein the circuitry configured to adjust the deep metric learning model is further configured to determine a loss value based on
a first value representing a difference between the clean feature vector and the label feature vector, and
a second value representing a difference between the multi-target adversarial feature vector and the label feature vector.
